(19) United States
(12) Patent Application Publication
(10) Pub. No.: US 2011/0046832 A1
(43) Pub. Date: Feb. 24, 2011

(54) Electronic Assistance System and Method

(75) Inventor: Nicolas Francoeur, Montreal (CA)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: VEHICULES NEMO INC., Laval (CA)

(21) Appl. No.: 12/706,672

(22) Filed: Feb. 16, 2010

Related U.S. Application Data
(60) Provisional application No. 61/153,023, filed on Feb. 17, 2009.

(51) Int. Cl. G06F 7/00

(52) U.S. Cl. 701/22

(57) ABSTRACT

An electronic assistance system and method for an electrical vehicle is provided that integrates the following functions: display of relevant information on the vehicle on a dashboard using visual or audio cues, as well as dials and/or graphical or alphanumeric displays; communication with people outside the vehicle through a loudspeaker; management of vehicle start-up; management of air conditioning, heating and defrosting; storage in memory of information on problematic states having occurred during operation of the vehicle; storage in memory of daily operating parameters of the vehicle; real time acquisition, ease of reconfiguration; and transmittal of stored operating data in order to generate vehicle operating behavior reports.

### CROSS-REFERENCE TO RELATED APPLICATIONS

This application claims priority to U.S. Provisional Patent Application No. 61/153,023, filed on Feb. 17, 2009, the disclosure of which is incorporated herein by reference in its entirety.

### FIELD OF THE INVENTION

The present invention generally relates to vehicle control systems. More specifically, the present invention relates to an electronic assistance system for control and management of an electrical vehicle and a method associated thereto.

### BACKGROUND OF THE INVENTION

There presently exists, on the market, measurement modules that can measure relatively precisely the status of a battery charge on an electrical vehicle. However, such systems use information that is already required for the vehicle's instrumentation. Using such modules results in a certain redundancy in subsystems. Integration of such systems appears to be necessary.

There exists several types of timers on the market that can be used, among other things, but are hard to adapt or use in conditions where other operating parameters must be taken into account, such as the status of the battery charge. Once again, integration of such systems is desirable.

In general, these two first examples of subsystems in electrical vehicles illustrate well the problem that exists in interrelating the information provided by each of these functions. Presently on the market, there appears to be no system that adequately integrates all the different functions that will be described hereinbelow.

### SUMMARY OF THE INVENTION

Embodiments of the present invention advantageously provide an electronic assistance system for management of events related to the operation of an electrical vehicle. In one embodiment, the system includes:
a circuit for acquiring vehicle data for a plurality of parameters associated with operation of said vehicle;
a processor coupled to the circuit for processing said vehicle data in order to determine whether operation of the vehicle meets at least one pre-determined condition and for generating event data for at least one operating event if said vehicle data meets said pre-determined conditions;
control ports connected to the processor for control of vehicle subsystems in response to the vehicle and event data;
a user interface coupled to the processor for displaying to an operator the vehicle and event data;
a data recorder for recording said vehicle and event data;
a data output port for connection to an external computer and transmittal of the vehicle and event data to said computer, said processor and computer generating at least one report characterizing the operating behavior of the vehicle,

in which the vehicle data includes at least one parameter selected from the group comprising battery pack state of charge, battery pack voltage, power transitions, battery pack temperature, and motor speed and the event data includes minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometer and charging time.

The vehicle subsystems nay be controlled through the control ports that include at least one subsystem selected from the group comprising a motor, a heating system and a defroster.

The user interface may include a dashboard and an external loudspeaker.

In another embodiment of the present invention, the data output port is connected to a transmitter for transmitting to a receiver the vehicle and event data, the receiver being remotely located from the vehicle. The receiver is connected to an application server, the application server generating and comparing one or more reports characterizing an operational behavior of a fleet of electrical vehicles.

According to further embodiments of the present invention, a method for characterizing behavior related to the operation of an electrical vehicle is provided. In one embodiment, the method includes the steps of:
acquiring vehicle data for a plurality of parameters associated with operation of said vehicle;
transmitting the vehicle data for the plurality of parameters associated with operation of said vehicle to a computer for real time analysis (RTA);
processing said vehicle data in order to determine whether operation of the vehicle meets at least one pre-determined condition;
generating event data for at least one operating event if said vehicle data meets said pre-determined conditions;
controlling vehicle subsystems in response to the vehicle and event data;
displaying to an operator the vehicle and event data;
recording said vehicle and event data;
transmitting to a computer the vehicle and event data, the computer generating at least one report characterizing an operating behavior of the vehicle,

in which the vehicle data includes battery pack state of charge, battery pack voltage, power transitions, battery pack temperature, and motor speed and the event data includes minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometer and charging time.

Accordingly, embodiments of the present invention advantageously integrate many functions, including, for example:
display of relevant information on the vehicle on a dashboard using visual or audio cues, as well as dials and/or graphical or alphanumeric displays;
communication with people outside the vehicle through a loudspeaker;
management of vehicle start-up;
management of air conditioning, heating and defrosting;
storage in memory of information on problematic states having occurred during operation of the vehicle;
storage in memory of daily operating parameters of the vehicle;
ease of reconfiguration; and
transmittal of stored operating data.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other advantages of the invention will become apparent upon reading the detailed description and upon referring to the drawings in which:

FIG. 1 is a schematic view illustrating the different subsystems of the electronic assistance system in accordance with a preferred embodiment of the present invention.

FIG. 2 is a detailed schematic view of the electronic interface shown in FIG. 1.

FIG. 3 is a detailed schematic view of the current converter block A shown in FIG. 2.

FIG. 4 is a detailed schematic view of the interface protection block B shown in FIG. 2.

FIG. 5 is a graph of thermistance vs. temperature in the interface protection block B shown in FIG. 4.

FIG. 6 is a graph of voltage vs. temperature in the interface protection block B shown in FIG. 4.

FIG. 7 is a graph of battery temperature vs. time during a test for battery cells 3 and 22 during an example of electrical vehicle travel between St-Jérôme and Lachute.

FIG. 8 is a detailed schematic view of the motor RPM interface block C shown in FIG. 2.

FIG. 9 are comparative graphs of VACC, START_SW and 72V_ON voltages vs. time during an ignition sequence.

FIG. 10 is a detailed schematic view of the ignition circuit block G shown in FIG. 2.

FIG. 11 is a detailed schematic view of the power output circuit block L shown in FIG. 2.

FIG. 12 is a detailed schematic view of the microcontroller block M shown in FIG. 2.

FIG. 13 is another detailed schematic view of the microcontroller block M shown in FIG. 2.

FIG. 14 is a detailed schematic view of the audio filter block N shown in FIG. 2.

FIG. 15 is a detailed schematic view of the audio amplifier block O shown in FIG. 2.

FIG. 16 is a front view of a state of charge display in accordance with a preferred embodiment of the present invention.

FIG. 17 is a detailed schematic view of the low voltage interface block P shown in FIG. 2.

FIG. 18 is a detailed schematic view of the dashboard interface block Q shown in FIG. 2.

FIG. 19 is a schematic view illustrating the different subsystems of the electronic assistance system in accordance with a preferred embodiment of the present invention.

FIG. 20 is a detailed schematic view of the 72V interface blocks A and B shown in FIG. 19.

FIG. 21 is a detailed schematic view of the 12V interface blocks shown in FIG. 19.

FIG. 22 is a detailed schematic view of the pedestrian horn amplifier block shown in FIG. 19.

FIG. 23 is a detailed schematic view of the CPI relay board block shown in FIG. 19.

### DETAILED DESCRIPTION

In the following description, similar features in the drawings have been given similar reference numerals and in order to way down the figures, some elements are not referred to on some figures if they were already identified in preceding figures.

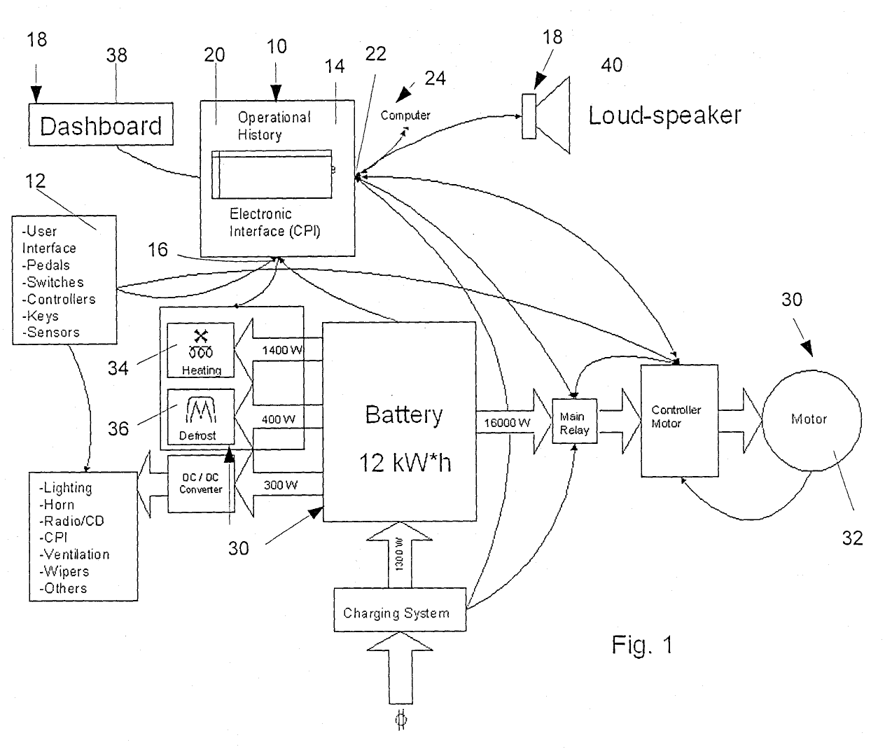

As shown in FIG. 1, according to the present invention, there is provided an electronic assistance system 10 for management of events related to the operation of an electrical vehicle. The system 10 comprises a circuit 12 for acquiring vehicle data for a plurality of parameters associated with operation of the vehicle. The system 10 also comprises a processor 14 coupled to the circuit 12 for processing the vehicle data in order to determine whether operation of the vehicle meets at least one pre-determined condition and for generating event data for at least one operating event if the vehicle data meets said pre-determined conditions. The system 10 also includes control ports 16 connected to the processor 14 for control of vehicle subsystems 30 in response to the vehicle and event data. The system 10 also comprises a user interface 18 coupled to the processor 14 for displaying to an operator the vehicle and event data, as well as a data recorder 20 for recording the vehicle and event data. A data output port 22 for connection to an external computer 24 and transmittal of the vehicle and event data to the computer 24 is also provided. The processor 14 and computer 24 generate at least one report characterizing the operating behavior of the vehicle. The vehicle data includes, among others, battery pack state of charge, battery pack voltage, power transitions, battery pack temperature, and motor speed. The event data includes, among others, minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometer and charging time.

Preferably, the vehicle subsystems 30 controlled through the control output ports comprise the motor 32, a heating system 34 and a defroster 36.

Preferably, the user interface 18 comprises a dashboard 38 and an external loudspeaker 40.

In another embodiment of the present invention, the data output port 22 is connected to a transmitter for transmitting to a receiver the vehicle and event data, the receiver being remotely located from the vehicle. The receiver may then also be connected to an application server, the application server generating and comparing one or more reports characterizing the operating behavior of a fleet of electrical vehicles.

According to other embodiments of the present invention, a method for characterizing behavior related to the operation of an electrical vehicle is provided. In one embodiment, the method includes the steps of:
acquiring vehicle data for a plurality of parameters associated with operation of said vehicle;
processing said vehicle data in order to determine whether operation of the vehicle meets at least one pre-determined condition;
generating event data for at least one operating event if said vehicle data meets said pre-determined conditions;
controlling vehicle subsystems in response to the vehicle and event data;
displaying to an operator the vehicle and event data;
recording said vehicle and event data;
transmitting to a computer the vehicle and event data, the computer generating at least one report characterizing the operating behavior of the vehicle,

in which the vehicle data includes battery pack state of charge, battery pack voltage, power transitions, battery pack temperature, and motor speed and the event data includes minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometre and charging time.

The electronic assistance system, also designated as the centralized Nemo™ vehicle management system (CPI) is an electronic module that integrates several functions related to management of an electrical vehicle. The management system includes measurement of parameters, interfacing with commands sent by the user, command of vehicle peripheral systems and audio or visual display of vehicle status. The invention also provides the possibility of storing information and making it available on demand. Such information can inform operators or managers of the vehicle on its history of operation.

The advantage of the present invention comes principally from the integration of several different functions that are interrelated. This integration provides cost reduction and increased system reliability, through a reduction in the number of components.

The possibility of also consulting the history of operation of the vehicle allows an adjustment of vehicle parameters in order to improve its operating efficiency and thus helps better evaluate proper usage of the vehicle.

The electronic assistance system, according to embodiments of the present invention, generates all the signals that are displayed on the dashboard. Certain signals require processing of various data, while other signals simply are processed in order to be adapted for display on the dashboard, while other signals are simply rerouted from the electronic assistance system toward the dashboard. The CPI must ensure that all the signals are provided to the dashboard in order to display the following information:
1. The principal battery charge status
2. An indicator of relative energy demand
3. Speed
4. Principal battery temperature
5. Elapsed operating time indicator
6. Overall vehicle status, including ready for drive, ready for reverse operation, not ready for drive, handbrake activator
7. Battery problem status indicator
8. Charging system indicator
9. Overheating motor indicator
10. Speed limiter activation indicator
11. Driver-destined warning sound

External Warning Sound System

The electronic assistance system can generate amplified sounds through an external loudspeaker. This subsystem provides the following functions. Firstly, the system offers a non-aggressive audio warning system for pedestrians that come in proximity of the electrical vehicle, which is typically too silent to be noticed. Secondly, the warning system when operating in a secondary mode produces an audio sound that is more continuous, more insistent, but tolerable. These two functions are related to the proximity warning system. The audio subsystem also is used to give information to an operator that is outside the vehicle. A particular sound is generated in the following situations, start-up of the vehicle, connection of the charging system and disconnection of the charging system. These functions are very useful. The external audio subsystem warns pedestrians that they be in proximity of the operating vehicle. Typically, these pedestrians would not notice the presence of the vehicle since electrical vehicles are very silent when out of view. The system also informs an operator that the charging system is well connected. During vehicle start-up, the sound produced by the system warns people outside the vehicle that the vehicle may soon move.

Management of Vehicle Start-Up

The electronic assistance system also manages vehicle start-up as it is an impression to the operator that he/she is using a conventional vehicle which uses a conventional ignition system and then generates a sound that the vehicle is ready for use. The CPI makes vehicle start-up impossible if the charging system is still connected externally.

Management of Air Conditioning, Heating and Defrosting

Operation of electrical vehicles also entails other particularities. Energy in such vehicles is limited and must be well managed. For this reason, the heating and defrosting systems, which are typically energy-consuming, are managed by the CPI through programmable timers. At the same time, the CPI manages ventilation within the vehicle.

Data Recorder Function

The electronic assistance system records and stores in memory various events, including time stamps, that are useful for people involved in maintenance of the vehicle and management of warranties. These events can be downloaded through a communication port connected to the CPI. The events that are tracked by the data recorder are the following: motor overheating, overheated battery temperature, excessive speed, low battery charge status, low main battery voltage, low accessory battery voltage, connection of CPI power, maintenance of battery refill not completed within time limits prescribed by operator's manual. This latter function is made possible through a pressure measurement device connected to the irrigation system and connected electrically to the CPI. The pressure in the irrigation system indicates that all the battery cells are filled or not and if there has been any re-charging.

Daily Reports

The electronic assistance system also records daily data that are used to evaluate the use of vehicle by the operator and also helps provide advice on vehicle operating behavior to follow, or even suggests modifications to be made to the vehicle depending on its use. These modifications can include, among others, a more powerful charging system, a more powerful motor, or a reduced speed limiter. This type of information can be downloaded through the communication port of the CPI. Daily information available from the electronic assistance system include, but are not limited to the following: date, minimum voltage of main and accessory batteries, number of stop-and-goes, minimum and maximum temperatures of main batteries, minimum and maximum charge status of main batteries, energy input through charging system, energy input through braking, output energy, elapsed operating time, distance travelled.

The use of the CPI through the data recorder, sheeting management system, daily reports and precise indication of the battery charge status, is very important as significant battery discharge is very bad for the overall service life of lead batteries. The CPI helps operators avoid significant battery discharge through an audio bip sound that is emitted when the charge status reaches a critical limit and also produces a visual cue identifying the problematic battery. The daily recorder will also document any use of the vehicle if nothing is done after receiving this first warning and if operation of the vehicle is continued and results in an additional 5% battery discharge. After this point, the battery charge status indicator will transition to a red color.

Extended Possibilities of the CPI

The CPI may be programmed for a majority of its functions. Herein below are presented some examples of variations of these functions that can be accomplished through reprogramming. These include change in battery types, change in tire diameter, change in activation limits for the data recorders, change in activation limits for alarms, heating and defrosting system time limits. Moreover, the sound emitted by the external loudspeakers may be modified.

The CPI also comprises analog and digital inputs that are not used, that can alternately be used for future instrument inputs including switches or status sensors.

The CPI also comprises non-used power outputs, that can be used to control future functions, including starters for emergency or secondary generators in hybrid vehicles.

The CPI can control a constant cycle of charge and discharge at a high charge rate, in order to increase the temperature of the main batteries while controlling use of the charging system and while controlling the vehicle heating system during external charging during the winter.

FIG. 1 is a schematic view illustrating the different subsystems of the electronic assistance system in accordance with a preferred embodiment of the present invention developed with the functions mentioned above.

The electronic assistance system provides management of lead acid batteries through judicious integration of functions that provide efficient management of the status of the lead acid batteries which are typically very fragile. The functions provided by the system include, among others, the following:
indication of the charge status with good precision, through an evaluation method using integration coulomb by coulomb at each operating second;
advance warning through visual and audio means of an approach of a critical charge status limit for the main batteries;
recording through the data recorder of operation of the vehicle at low charge, although the operator has been informed in advance through a visual indicator. Such operation is prescribed by the operator manual;
recording through the data recorder that maintenance irrigation of the batteries has not been accomplished within the time limit prescribed by the operator manual;
possibility of more precise diagnostics of vehicle operation through daily reports;
integration of management of energy-consuming accessories, including heating and defrosting;
control of the options that can influence reliability of the batteries such as an emergency or secondary generator through knowledge of several battery parameters;
control of a constant cycle of charge and discharge in order to increase the temperature of the main batteries through control of operation of the charging system, while controlling the vehicle heating system during external charging in winter. The aim of such a feature is to increase the battery temperature while increasing performance while maintaining a state of charge close to 100% if time-permitted.

The electronic assistance system integrates several functions, including instrumentation, battery management, start-up logic as well as data recording in a same module. This provides an advantage in terms of reliability and costs related to manufacturing of an electrical vehicle.

The electronic assistance system is reprogrammable with respect to most of its functions and can therefore be adapted to various changes. The system also includes additional input and output connections in order to adjust to changing surrounding environments or subsystems.

As mentioned previously, the electronic assistance system records various types of information that are useful for customer support and management of warranties.

Description of Hardware Interfaces

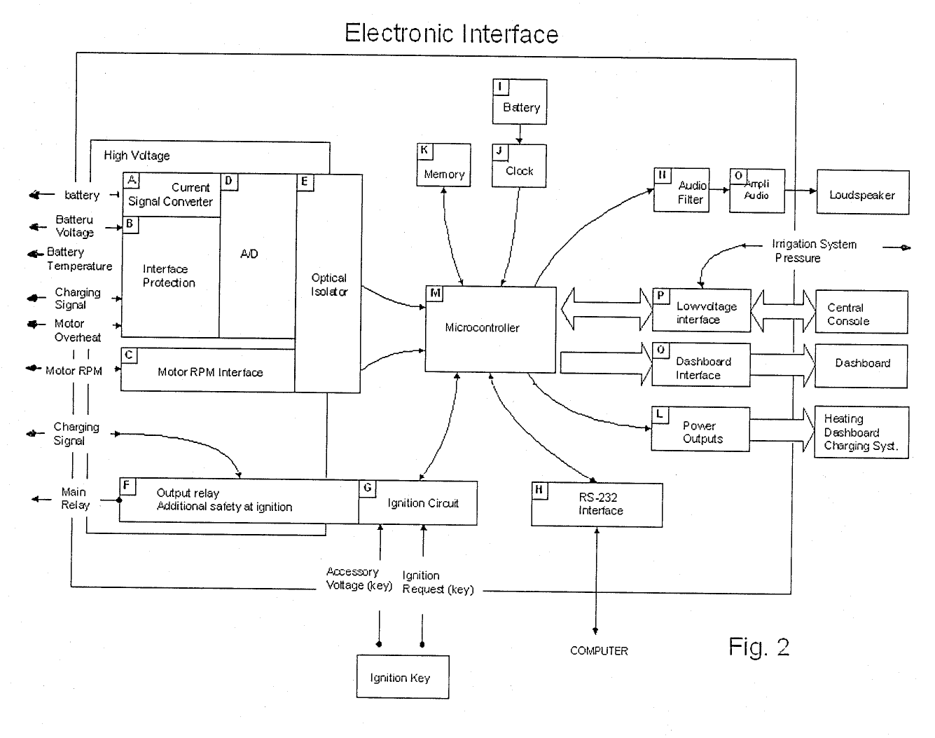

FIG. 1 illustrates the different interfaces with the electronic assistance system in accordance with a preferred embodiment of the present invention. The system comprises a central processor interface (CPI), better shown in FIG. 2, which reads information provided by the operator and by the vehicle. These elements of information are displayed on the dashboard cluster and are also provided as audio feedback through loudspeakers and the cluster. The CPI also controls ventilation, heating, defrosting and the main relay of power to the vehicle. Certain events whether useful for further development of the vehicle or for management of warranties are stored by the CPI and information related to these events is available through computer access.

The CPI is explained in more detail below through schematic diagrams. The high voltage part of the CPI, i.e. the part referenced to the ground corresponding to the power battery (72V) comprises functional blocks A to F as illustrated in Figure YY. The other functional blocks are referenced to the ground corresponding to the accessory battery (12V). Functional blocks A and F are the only ones to refer to two references and serve the purpose of isolated links between the two major subsystems. High voltage signals are issued from the power battery, from a connected charging system, from the traction motor, from the traction motor controller and from the principal power relay. The different functional blocks will be explained in more detail below.

A—Current Converter

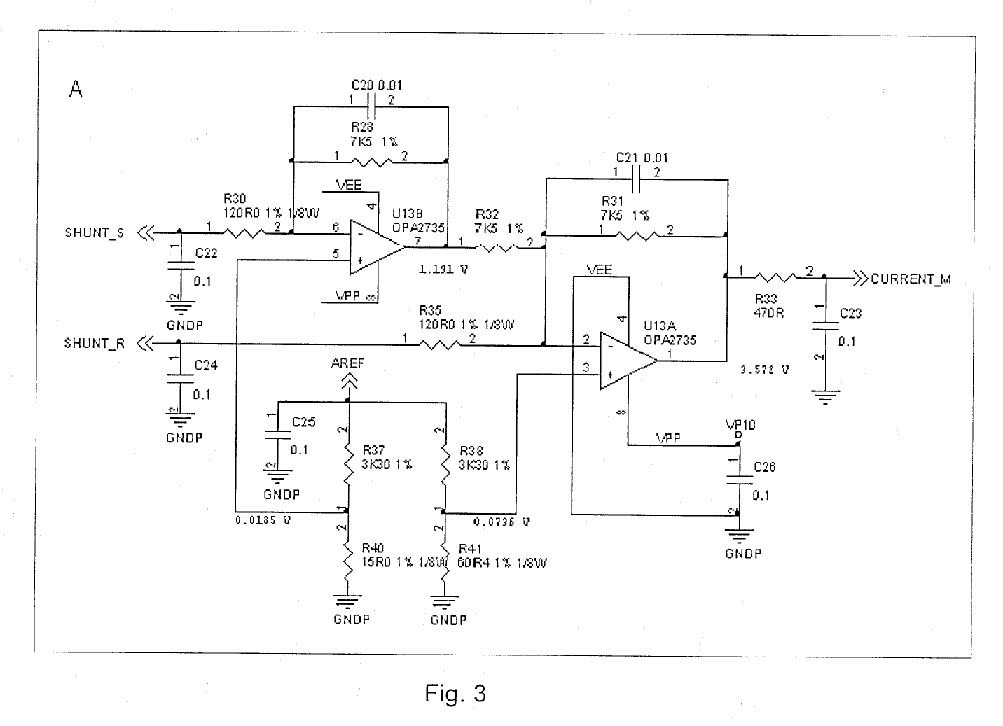

As shown in FIG. 3, the current converter comprises principally a standard double operational amplifier. The first amplifier takes directly one of the two signals from the reference shunt, and amplifies it with negative proportion. The output of the first amplifier is reused in a summer (the second one) with respect to the other signal from the reference shunt. The sum of the two signals, if the other one is inversed, becomes a differentiator. This difference is amplified, in order to convert the shunt millivolts, into a higher voltage that is especially always positive. The gain of the amplifier is set in order to respect the voltage range of the converter, the current range of the vehicle, and the resistor value of the shunt. The reference voltages of the two amplifiers are offset, which allows one to work using a positive voltage. This produces a circuit at very low cost. However, this offset has very little precision and must be known by a microcontroller, in order to know the zero Ampere reference measurement. Its precision depends on the tolerances of 12 components. That is why, a calibration, which will be stored in non-volatile memory in the microcontroller, must be made at the same time as the validation tests of the electronic circuit.

A.1—Reference Shunt

The reference shunt is positioned between the 72V battery pack of the vehicle and the mass of the motor controller. All devices connected to the same reference 72V ground should be connected at this point, at the controller. The SHUNT_S signal is connected on the battery side, while the SHUNT_R signal is connected on the motor controller side.

B—72V Interfaces

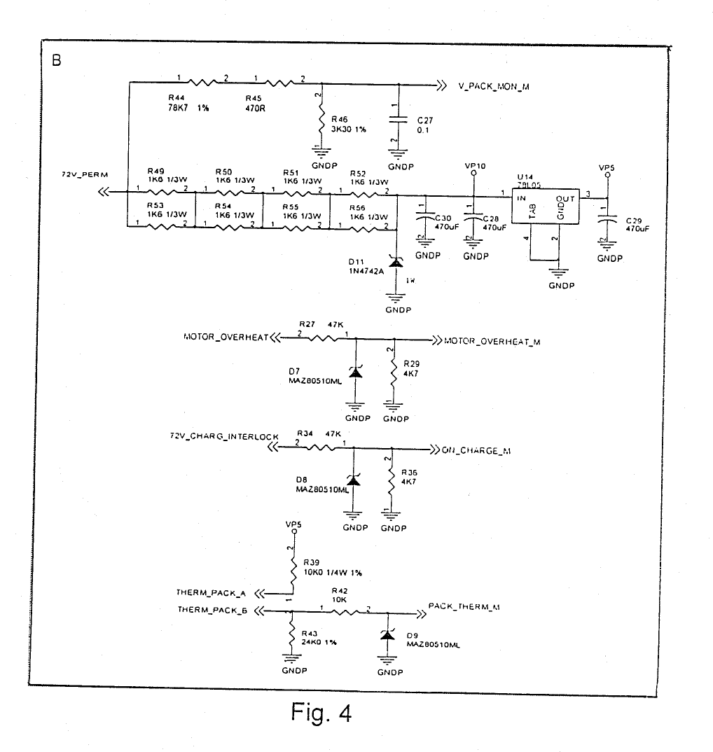

As shown in FIG. 4, the 72V interface circuit is relatively simple. It allows the conditioning of the power supply voltage, the motor overheating signal, the charging system presence signal and the charging system thermistance signal.

VP10 is built by a regulator comprising a resistance and a Zener diode. The very low consumption of circuits fed through VP10 allows the use of an inexpensive regulator which unfortunately takes up more space and generates heat. It uses a voltage of about 12V with very little precision.

VP5 comes from a regulator 78L05 from VP10.

72V_PERM corresponds to the battery pack voltage. There is a signal protected at 10 A. The interface then proceeds with a division by 25 in order to do a reading at low voltage.

MOTOR_OVERHEAT: The signal comes from the thermal interrupter placed on the vehicle motor. The presence of a 72V voltage indicates that the motor is not overheating, while a floating signal indicates overheating. The interface allows transformation of this logic in 5 Volts-Volts.

72V_CHARG_INTERLOCK: This signal comes from the battery charging system. The presence of a 72V voltage indicates that the charging system is not connected to the vehicle, while a floating signal indicates that the charging system is connected to the vehicle. The interface allows transformation of this logic in 5 Volts-0 Volts.

THERM_PACK_A and THERM_PACK_B: These two inputs are connected to a thermistance which is in turn connected to one of the battery pack terminals. This variable allows an evaluation of battery temperature.

B.1—Thermistance

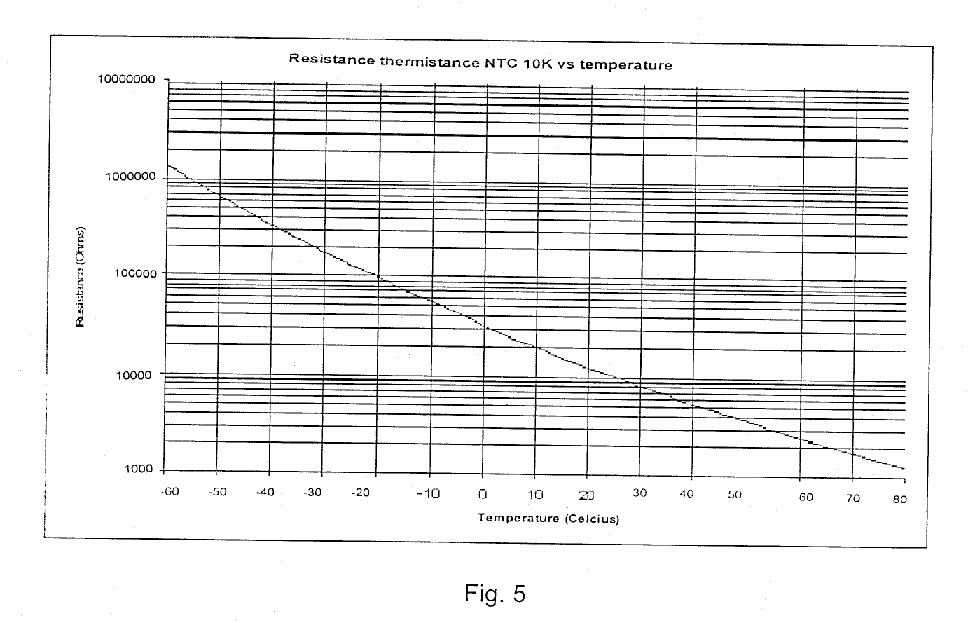

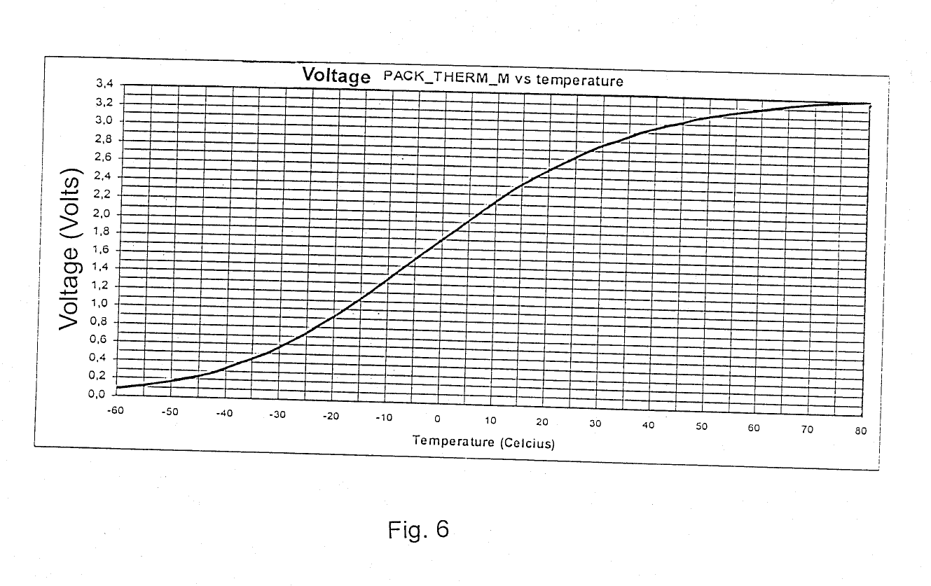

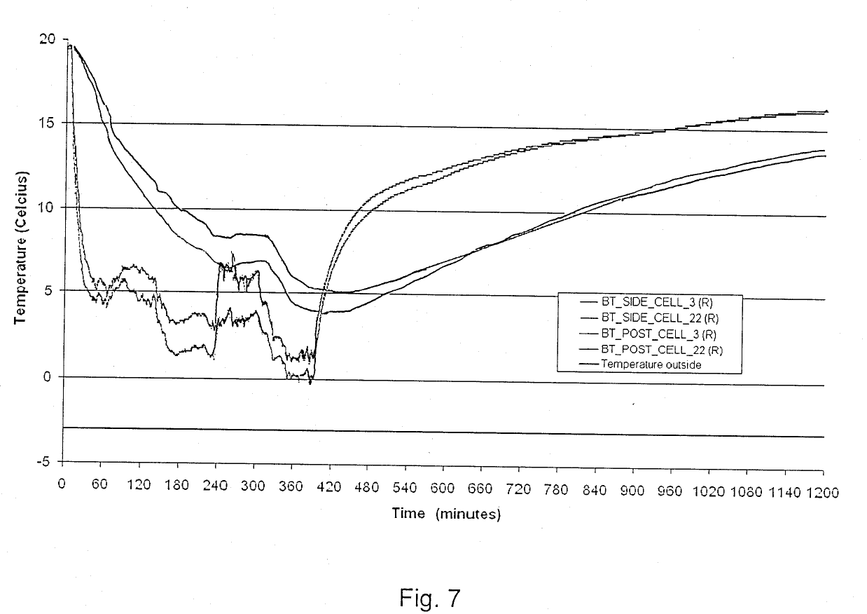

The thermistance used in this block is 10K because it has a 10 KOhms resistance at 25° Celsius. The interface allows conversion of this resistance into a readable voltage. This thermistance is encapsulated in a copper electrical terminal in order to measure the temperature of a threaded terminal of one of the batteries. Consequently, the temperature of a terminal of one cell over 36 will be used to evaluate the global temperature of the battery pack through calibration graphs as shown in FIGS. 5 and 6. This measurement is evidently an estimate, with a probable error because the measurement is only on one cell, and the sensor is not inside the cell, but outside on a terminal post. So, we measure the temperature between 5 ambient air, and inside the battery. This issue is well resolved by using a software time constant filter.

C—RPM Motor Interface

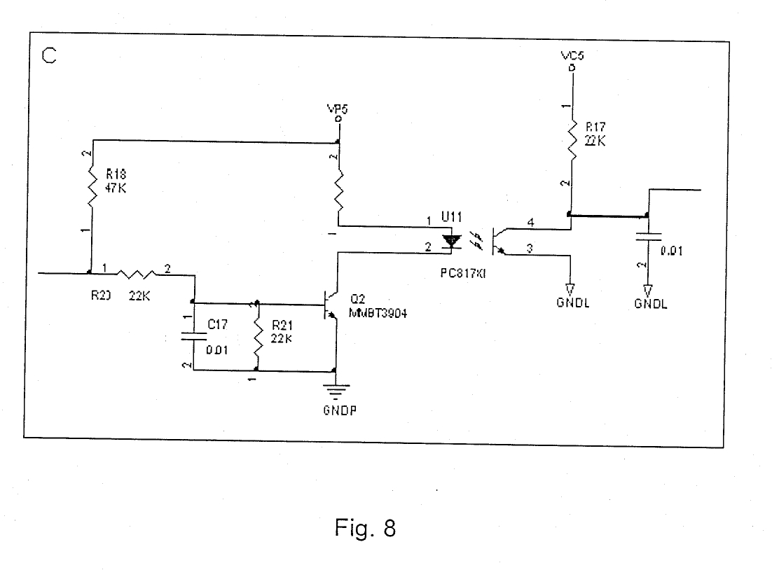

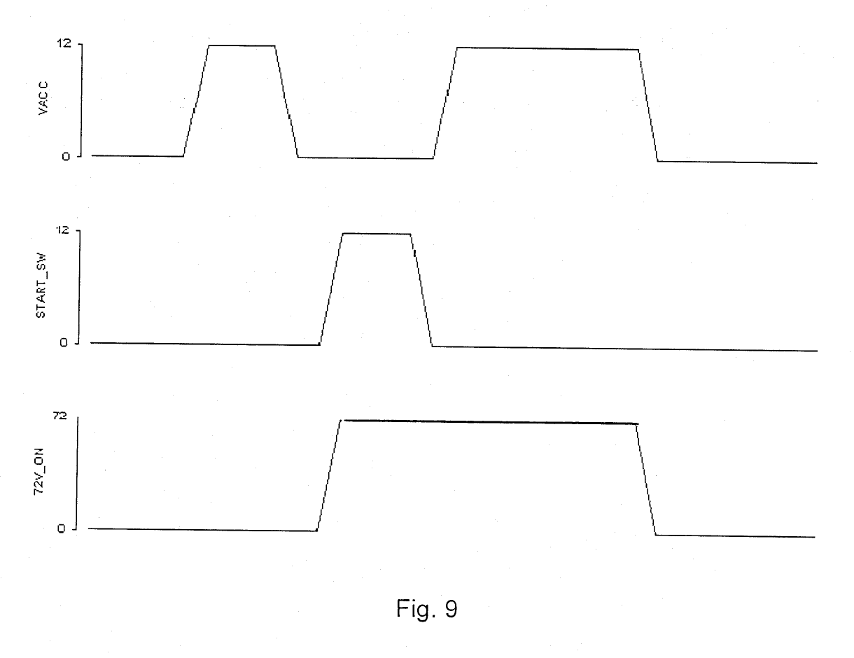

As shown in FIG. 8, the motor RPM signal comes from a Hall effect sensor on the motor. It is fed by the motor controller through a 5V voltage. It is therefore a signal that is primarily destined for the controller and which is used by the system. The signal is referenced to the 72V ground as is done for all of the motor controller signals. It generates four 0-5V pulses per motor turn. The signal is generally subject to significant amount of noise. The interface circuit has a sufficiently high impedance in order to not significantly affect the signal which must end-up intact at the controller. The capacitor provides adequate noise filtration before switching the transistor. A second filter is provided at the output after the optocoupler. The chosen optocoupler functions at low speeds, is of low cost, is easy to purchase and has several equivalent components, like the transistor.

D—Analog to Digital Converter

The converter used is a low cost one and uses SPI communication, a protocol adopted as a mode of communication between the microcontroller and its peripherals. A reference voltage is required and may be changed according to the desired precision.

E—Optical Isolators

Other than the RPM and start-up signals, all the signals referenced to the 72V go through the external analog to digital converter to the microcontroller. In order that the information go through the microcontroller which was referenced to 12V, it must be isolated electrically. In order to do so, for synchronous series communication signals must be interfaced. The optocouplers for interfacing MASTER_OUT, SERIAL_CLOCK and MASTER_IN must be relatively high-speed optocouplers because the minimum communication speed of the microcontroller is relatively high. However, the ADC_SELECT signal which is used to warn the external analog to digital converter that a communication is being solicited, does not have the same high-speed requirement.

F—Vehicle Start-Up Relay

A relay is used to interface the start-up output for two reasons. Electrical isolation is required as well as power. These two requirements are sufficient for requiring the use of a relay. The relay is used to allow or block activation of the principal vehicle relay through a serial connection with the circuit that activates the principal relay coil. Connection is done in the following manner. The relay contact input is fed by the interlock signal from the charging system. If the charging system is connected, a floating signal is obtained and if the charging system is disconnected a 72V signal is present. The typically open relay output is connected to a positive terminal of the principal relay coil. The negative signal from the coil comes from the motor controller. Consequently, three vehicle components are involved in activation of the principal relay. These components include the charging system, the motor controller and the CPI, as described in this document.

G—Vehicle Start-Up Circuit

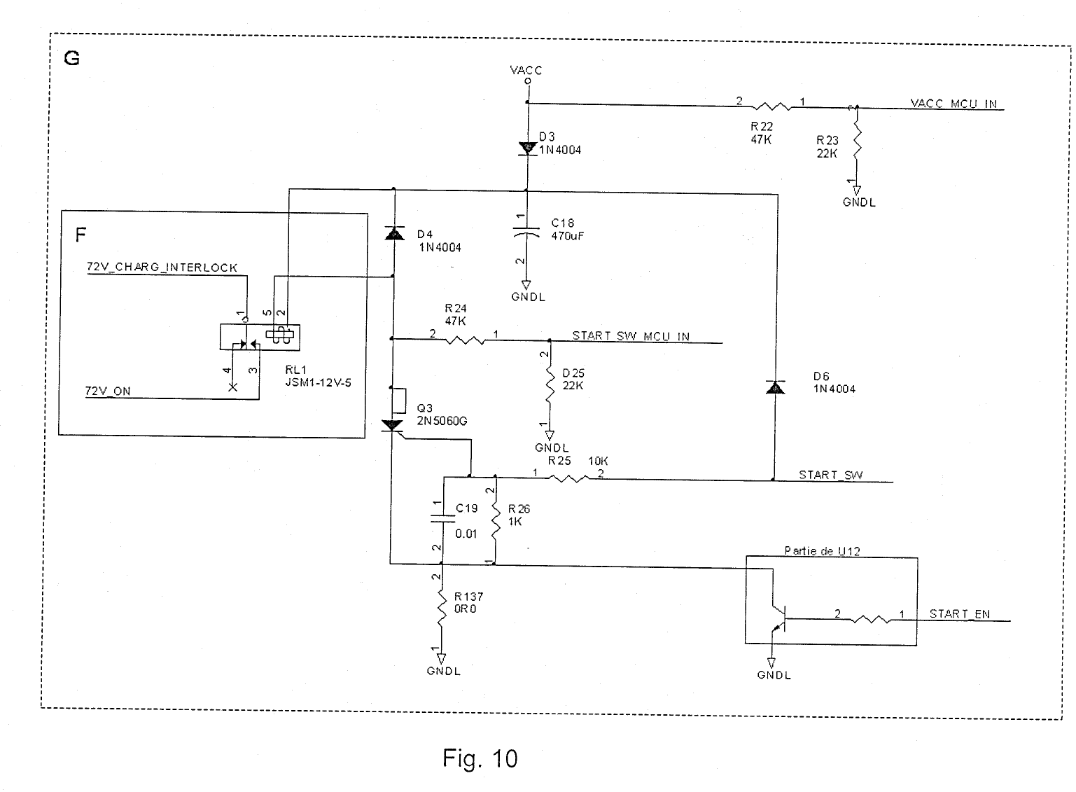

The CPI is involved in the approval of the eventual start-up of the vehicle. The start-up circuit, as shown in FIG. 10, requires an accessory voltage (VACC) and an instantaneous start-up signal (START_SW) to activate the relay. As these two signals come from the same source, from the ignition key, the sequence must be well understood in order that the circuit functions properly. When the ignition key is completely turned in a clockwise direction in its instantaneous ignition position, the accessory voltage disappears as long as the key is maintained in its instantaneous position. Moreover, between the non-start-up and start-up states, it is possible to position the key between the two. In this position, no VACC voltage and no START_SW voltage are available, as shown in FIG. 9, hence the need to use a capacitor (C18) for maintaining voltage at SCR Q3. If contact is cut through removal of the ignition key, accessory voltage will be lost and the relay will be deactivated.

The latch function of the circuit is accomplished through an silicon-control rectifier (SCR) and a set of diodes. Moreover, feedback is returned to the microcontroller in order to verify the presence of accessory voltage (VACC_MCU_IN) and to verify activation of the SCR (START_SW_MCU_IN). This allows the microcontroller to activate the ignition audio signal. Also, as an option, this also allows a possibility of the microcontroller to deactivate the relay without having the possibility of activating it. This function is possible, through removal of the zero Ohms resistance, R137, and through activation of a software function. The concept behind this design is to keep the ignition decision to material hardware and thus avoid problems associated with software given the importance of this function. Consequently an engine immobilization function is possible.

H—RS-232 Interface

The circuit is a typical MAX232 circuit. The RS-232 communication protocol is chosen because it is already required during service in order to communicate with the motor controller. This interface circuit allows transformation of the Tx from 0V 5V into −12V+12V and the Rx from −12V+12V into 0V-5V, as stipulated by the RS-232 protocol. In practice, this protocol is permissive and accepts +/−8V.

I—Internal Battery

The internal battery allows only storage of the date and time. It is predicted to last 10 years.

J—Internal Clock

This function allows providing information to the microcontroller on the date, time and year. This data is important as much for the data recorder, as for future development of the vehicle which requires generation of daily reports on input/output energy, mileage, charging times and separation from charge charging times as well as times when the vehicle is not being charged, etc.

K—Additional Memory

This memory function is used for daily reports. The non-volatile internal memory of the microcontroller is used for the vehicle parameters, calibration parameters and for storage of data recorder events. The memory is presently a 32768 bytes memory. Each daily storage event comprises 16 bytes and therefore 2048 days of report can be stored, which corresponds to five years of storage.

L—Power Output Relays

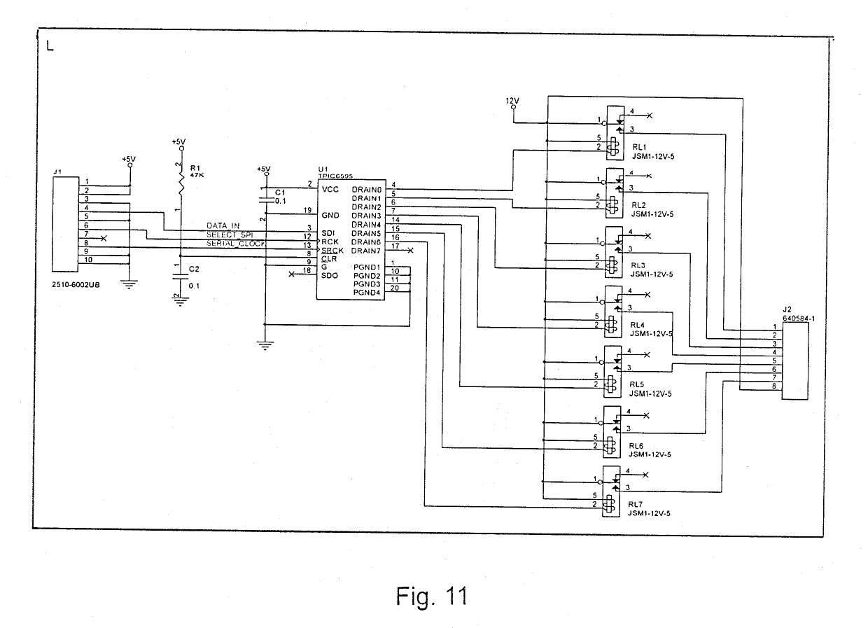

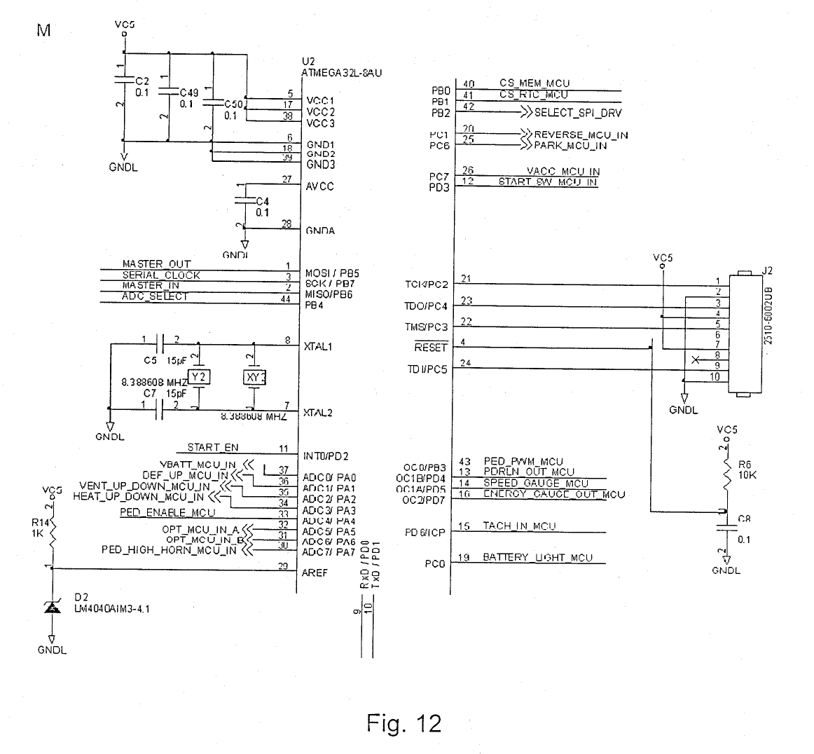

As shown on FIG. 11, this circuit is on a separate board from the main board. The communication link with the main board is inferred through SPI communication. This circuit allows the power feed of the three speeds of the ventilator, the defroster relay and the heating relay. Presently two outputs are not being used and are free for future options. The relays used in this circuit are automotive quality relays and are therefore low costs and easy to procure. It is possible to use multiple circuits for the purpose of having more control output. The connector J3 is built to permit connection to another identical connector, giving the opportunity of connectors in serial.

M—Microcontroller

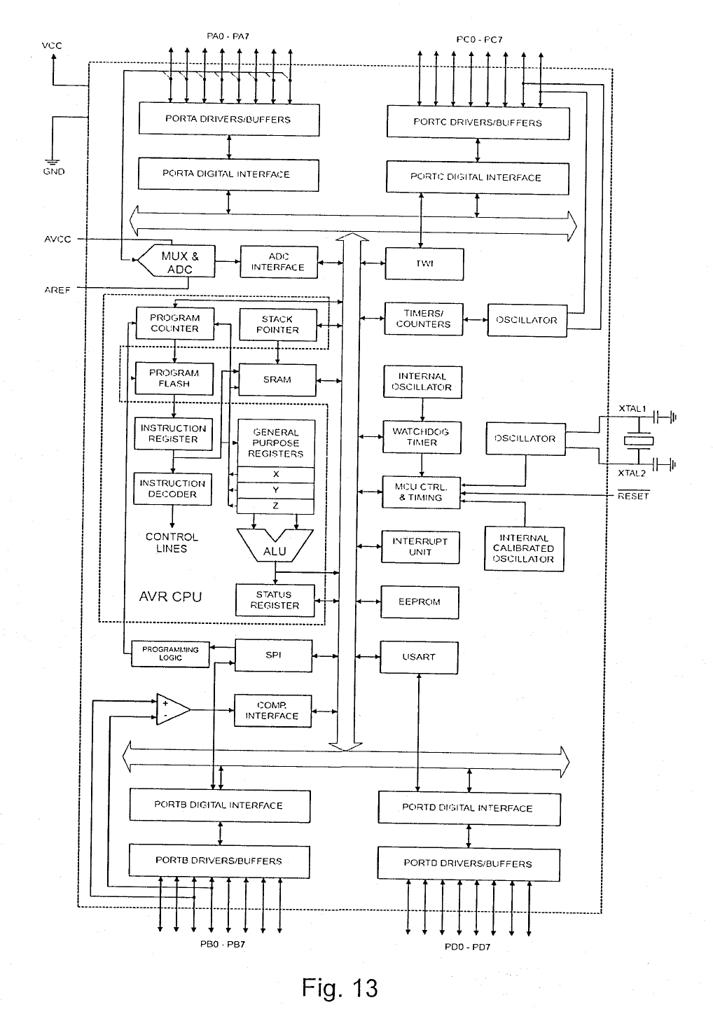

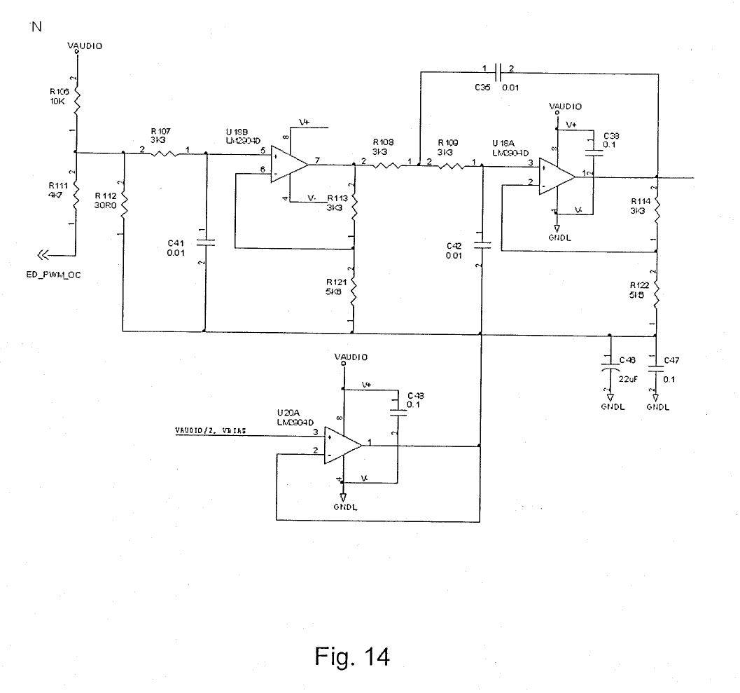

As shown in FIGS. 13 and 14, the microcontroller used in the system is preferably an ATMEGA32. The crystal frequency is 8.388608 MHz (223). The microcontroller includes interrupters and counters.

M-1: Processor Interrupts

Three interrupts are used: two in hardware and one in software.

The first in order of priority is the RESET interrupt. It corresponds to the hardware interrupt on pin #4, zero logic. This interrupt kicks-in when capacitor C8 is not charged but when there is a VC5 feed. It is used at the start of the program when the system is being reinitialized. To simplify, if the permanent 12 Volts power of the CPI is unplugged, the software is reset. Unplug 72V and/or 12V accessory of the CPI didn't create a reset interrupt.

The second interrupt in terms of priority is TIMER1 CAPT. This hardware interrupt on pin #15 on the raising front. This interrupt is used to measure vehicle velocity, to detect vehicle movement and to update the odometer.

The third interrupt in terms of priority is TIMER0 OVF. Several tasks are integrated into this interrupt. Principally, it provides a pulse to the program for events that must be repeated periodically. The interrupt occurs when counter 0 reaches its maximum at 256 machine cycles. Consequently, at every 256 cycles, the interrupt operates. It is therefore executed often at every 30.52 μs.

Four principal functions are managed by this interrupt:
update of time management variables
generation of the PWM signal for the audio output;
generation of a variable frequency signal for display of speed;
generation of PWM signal for PDRLN display.

N—Audio Filter

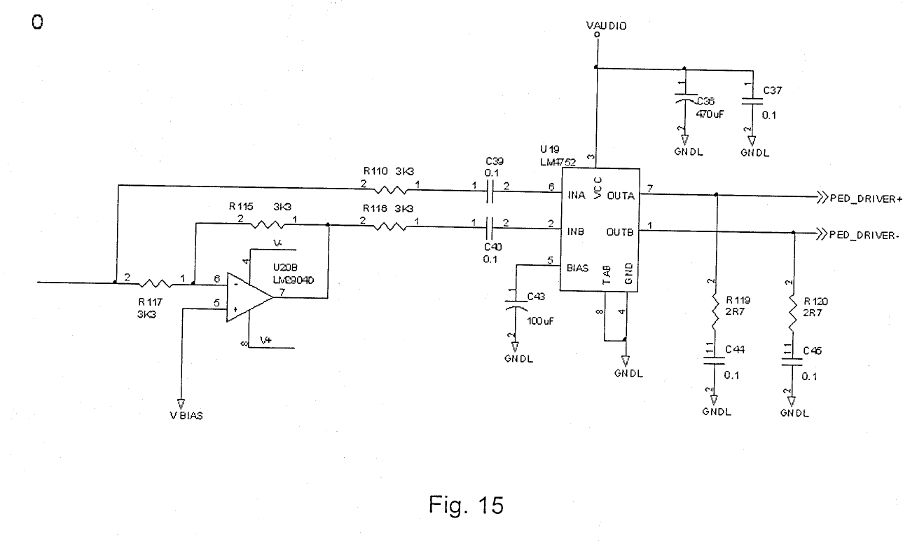

As shown in FIG. 15, the audio filter allows the use of a PWM output from the microcontroller and converts it into an analog signal. For the required audio quality this filter is sufficient. The objective of this component is to remove high frequency components that risk overheating the power application stage and improving the audio output quality. The circuit is a three pole low-pass filter. The cut-off frequency is: 4823 Hz

The lower amplifier is used to create a virtual mass located between VAUDIO and GNDL. It is a mirror of V BIAS of the output power amplifier. Following this reference voltage avoids distortions due to signal clipping during activation of the amplifier and filter.

O—Audio Amplifier

As shown in FIG. 15, the configuration used is a differential configuration. In other words, a stereo amplifier is used with a differential mono signal at the input. The Amplifier used is a LM4752, with a fixed gain.

P—User Output Interface

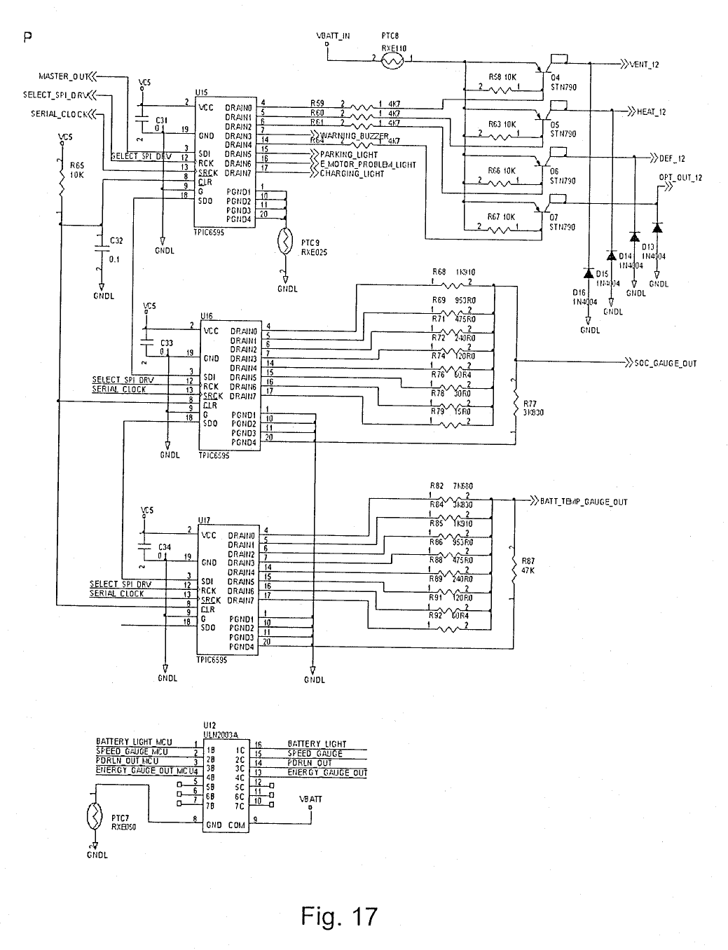

As shown in FIG. 17, this interface provides information to the user. Principally, the circuits are used to transmit information to the cluster or dashboard. The battery temperature and battery state of charge inputs are resistive. The speed and energy demand inputs are frequency inputs. The state of the transmission is a PWM input at 50 Hz. The illuminated indicators on the dashboard activated by the CPI are all activated by the ground input. U15 is used to feed certain cluster inputs that require a ground as well as three 12V signals that feed the illuminated indicators of the switches on the center console, for ventilation, heating and defrosting. The diodes are used in cases where an inductive load must be fed. The PTC9 is used as protection in case of a short-circuit at the output.

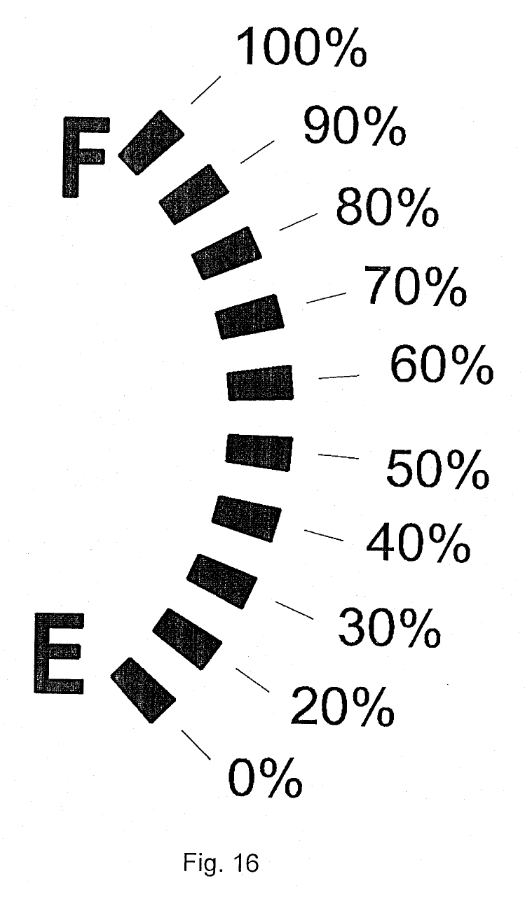

U16 is used to generate a variable resistance to activate the state of charge indicator. Software will activate the U16 transistors in order to generate the required resistance for the desired display. In the red zone, in the example shown in FIG. 16, resistance is increased from 0 to 20% and after, for each additional black mark on the display, the state of charge is increased by 10% as illustrated below.

For the temperature indicator the excessive cold limit is at −10° Celsius (red), while the excessive heat limit is at 42° Celsius (red). The indicator is positioned at the center at 25° Celsius. Simulated resistance is accomplished by U17 through a network of associated resistors.

U12 is used to generate grounding signals that come directly from the microcontroller.

Q—User Input Interface

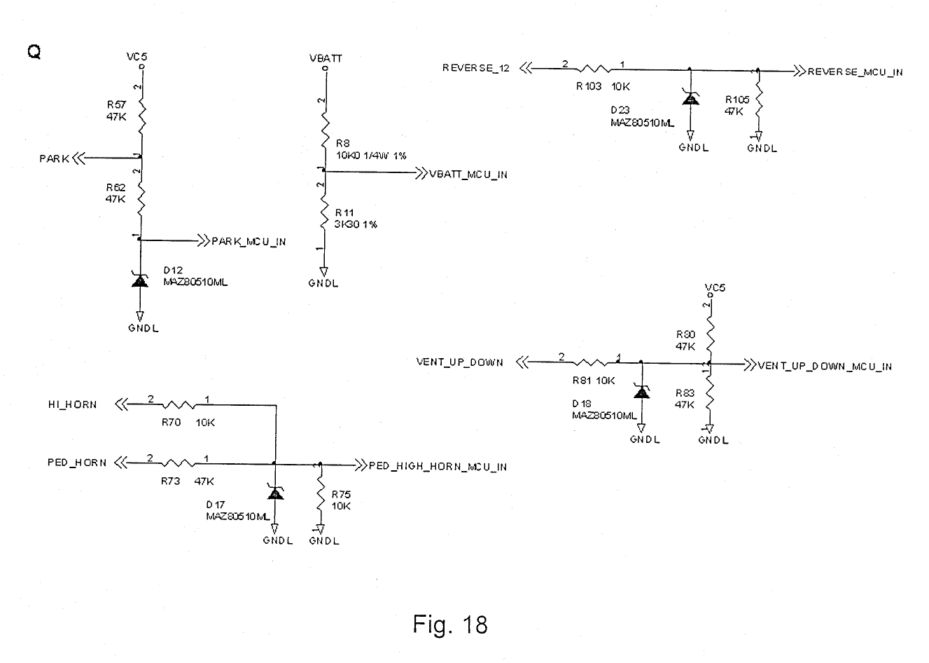

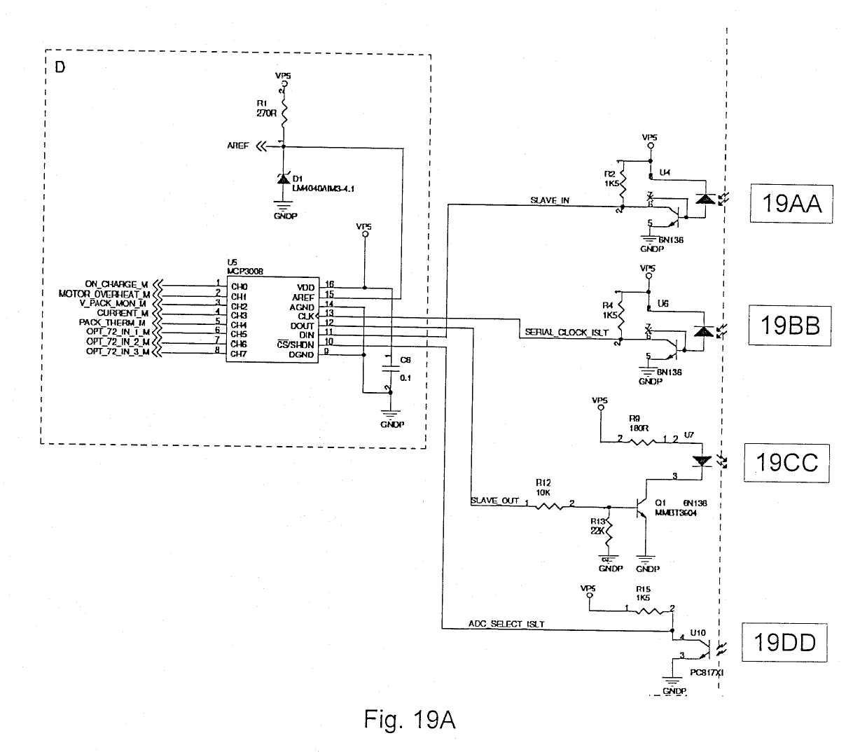

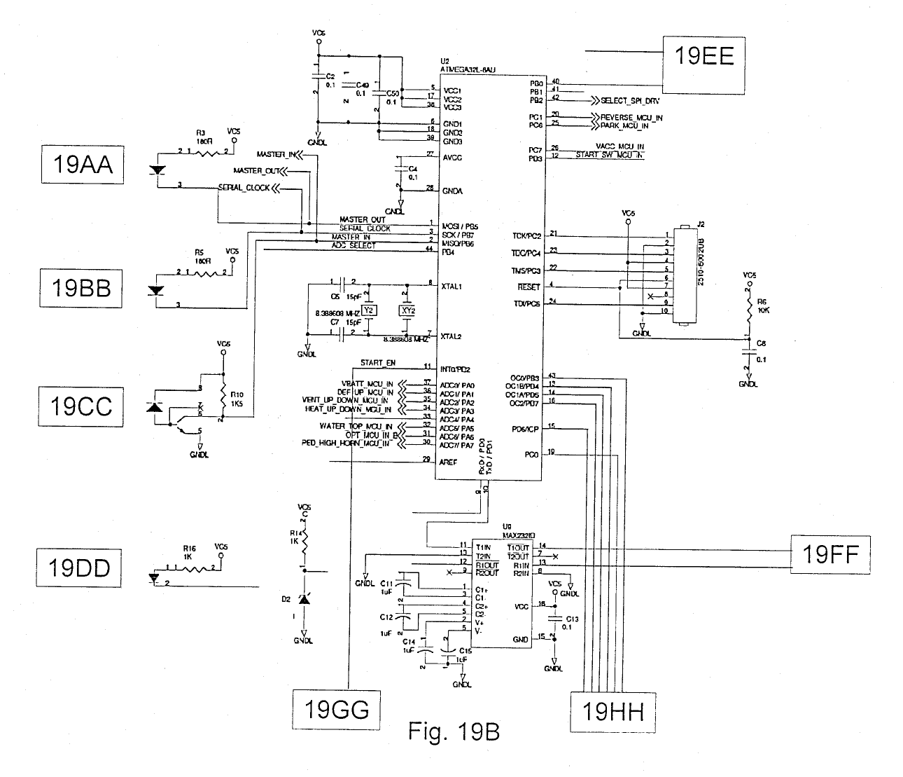

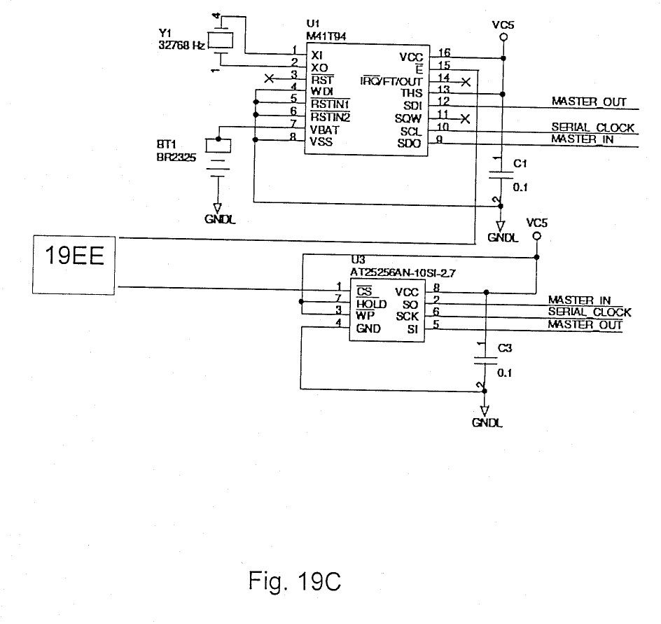

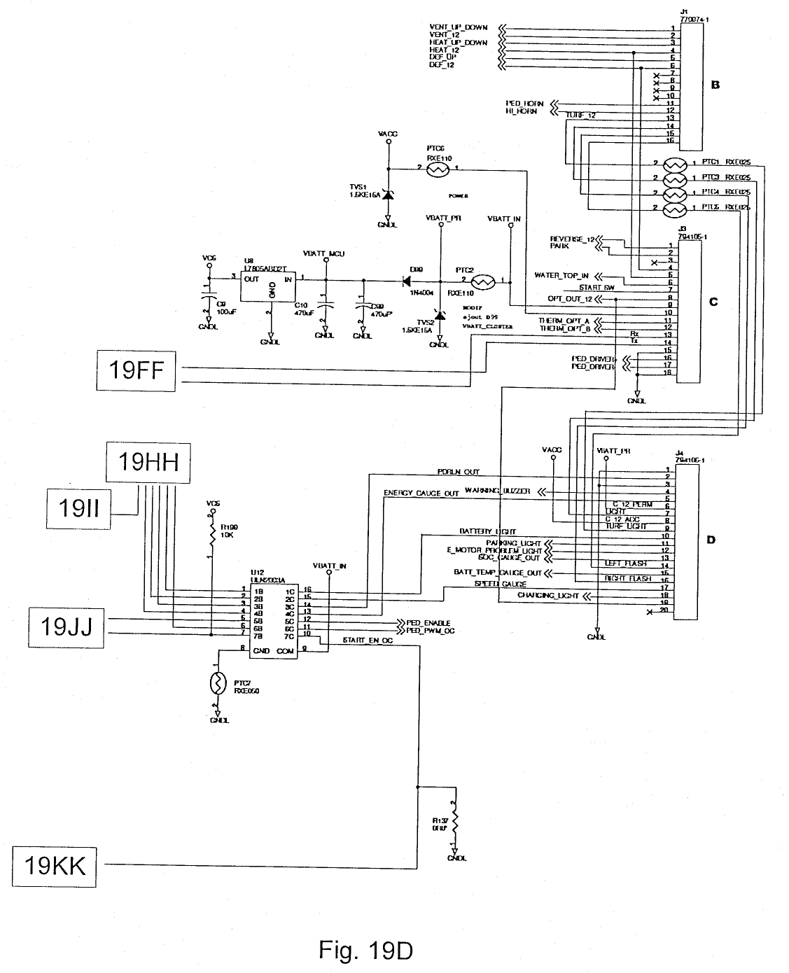

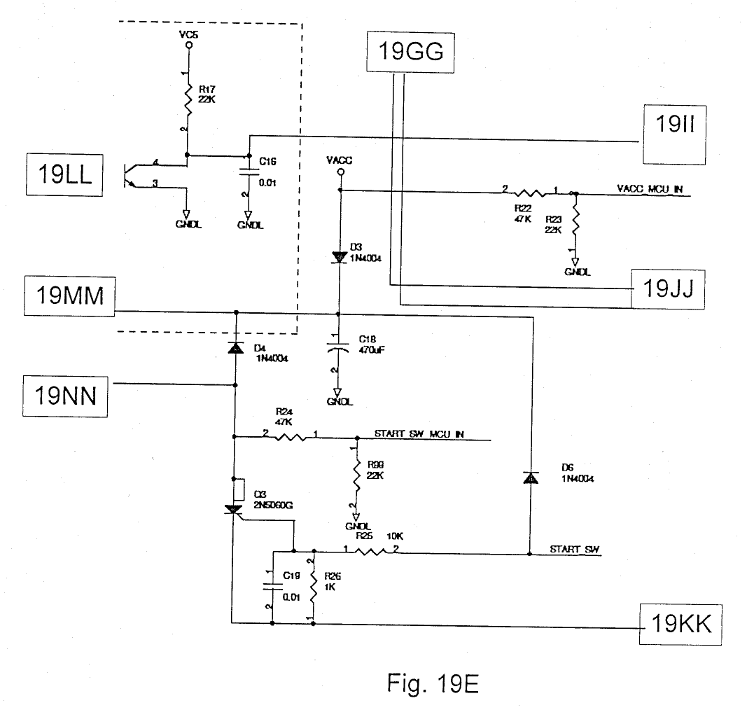

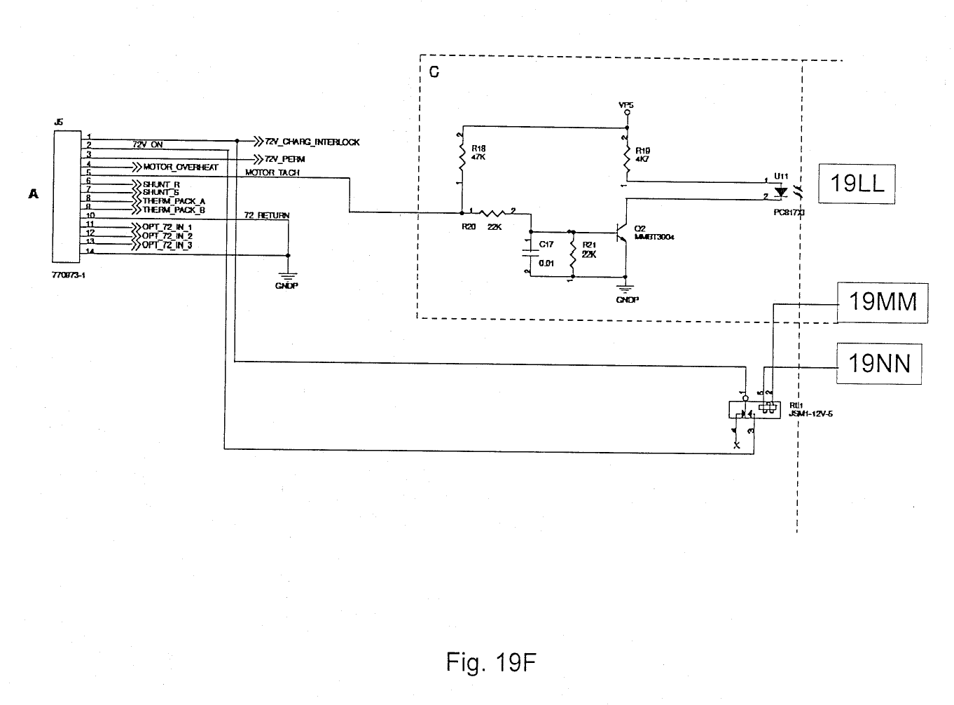

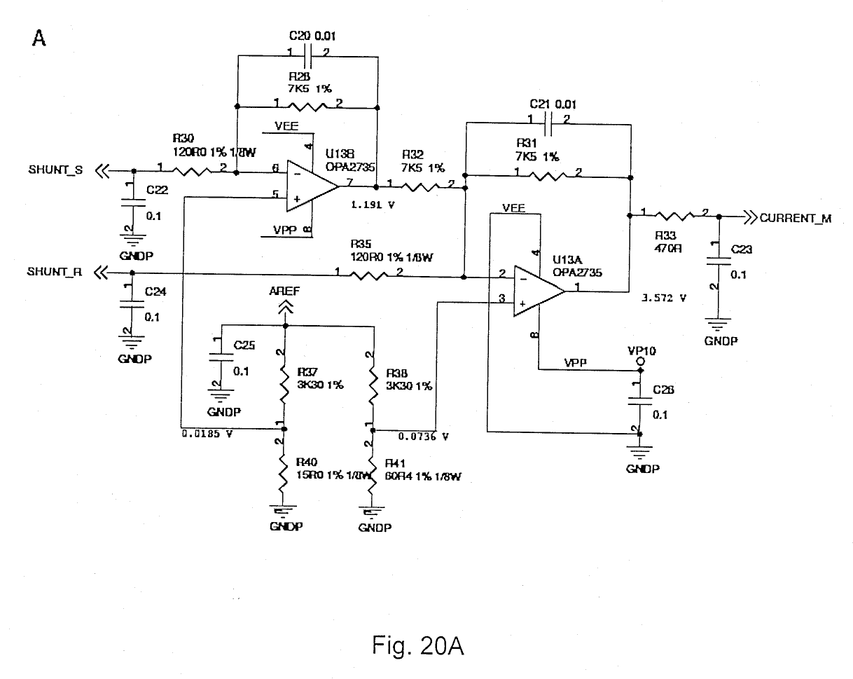

The first circuit illustrated in FIG. 18 converts the PARK signal whether it be fixed or floating into 0-5V. The second circuit measures battery voltage. It is a simple voltage divider. The third circuit converts the REVERSE_12 signal from 0-12V to 0 5V. The fourth circuit has a three-state logic. With an analog input one can deduce the state of the two floating signals −12V. The last circuit is also a three-state interface. Ground, floating of 12V generate either 0V, 2.5V or 5V. This example is used to read ventilation commands. A similar circuit is used to control heating.

Software Elements of the Electronic Assistance System

The software elements of the system comprise a certain number of special functions. These special functions are defined as functions that do not interact directly with the functioning of the vehicle. These functions, if they did not exist, would have no impact on operation of the vehicle from the point of view of an operator.

Data Recorder Function

The data recorder function allows identification of abusive uses of the vehicle and has been designed with this goad in mind. Through this function, it is desired to obtain information on battery and motor usage. Recording of usage is particularly useful during a development phase of the vehicle but has mainly been designed for management of battery and power train warranties. The data recorder will record the date and period of the day when an event occurred and if the problematic status disappears, the data recorder will record the date and period of the day when the problem disappeared. The data recorded recognizes four different periods per day: midnight to 6:00 am, 6:00 am to noon, noon to 18:00 and 18:00 to midnight. The data recorder will also record additional information related to the problem. For example, if the data recorder registers an elevated battery temperature problem, the additional information will be the maximum temperature recorded during the period in which the temperature is above a pre-established limit. In certain cases, the additional information might be or less useful but the data structure within the data recorder provides memory spaces that are used as much as possible even if the information is more or less relevant. It is possible to store at least 96 data record in parameters in the non-volatile memory.

Herein below is a detailed list of different events monitored by the data recorder:

MOTOR_OVERHEAT

This event occurs if the motor overheats or if the motor temperature sensor is disconnected. Additional information included with this event is the battery state of charge at the beginning of the problem and the maximum motor RPM during the problematic period.

MOTOR_RPM_TOO_HI

This event occurs if vehicle travels at excessive speeds, due to its presence on inclined surfaces, due to improper towing or if the speed sensor is defective. Additional information associated with this event include the battery state of charge at the beginning of the problem and the maximum motor RPM during the problematic period.

BATT_TEMP_SENSOR

This event occurs if the battery temperature sensor is disconnected or short-circuited. The additional information for this event includes the battery state of charge at the beginning of the problem and the minimum accessory voltage during the problematic period.

LOW_SOC

This event occurs if the battery state of charge goes before a set minimum limit. The additional information associated with this event includes the minimum state of charge recorded during the problematic period and the maximum battery temperature during that same period.

BATT_TEMP_HI

This event occurs if the battery temperature exceeds a set maximum value. The additional information associated with this event includes the minimum state of charge recorded during the problematic period and the maximum battery temperature during this same period.

WATER_SERV_OMMITEDS

This event occurs when battery irrigation maintenance is not done within prescribed time limits.

ACESS_VOLT_LOW

This event occurs if the accessory battery voltage becomes too low. Additional information related to this event includes the minimum voltage of the accessory battery and the minimum voltage of the main batteries during the problematic period.

PACK_VOLT_LOW

This event occurs if the main battery voltage becomes too low. Additional information related to this event includes minimum voltage of the accessory battery and minimum voltage of the main batteries during the problematic period.

CPI_RESET

This event occurs if the CPI software is reinitialized even if the 5V CPI voltage has been maintained. This parameter allows detection of problems associated with the CPI hardware of software. Additional information related to this event includes minimum voltage of the accessory battery and minimum voltage of the main batteries during the problematic period.

CPI_{—}5V_LOW

This event occurs if the CPI software is reinitialized and the 5V CPI voltage has been at a critical level. The event occurs if the accessory voltage is cut from the CPI or due to CPI internal problem. Additional information associated with this event includes minimum voltage of the accessory battery and minimum voltage of the main batteries during the problematic period.

CPI_RTC_BATT_LOW

This event occurs if the CPI internal battery voltage is too low. Additional information related to this event includes minimum voltage of the accessory battery and minimum voltage of the main batteries during the problematic period.

UNPLUG_LAST_WEEK

This event occurs if the vehicle is not connected to a charging system during a complete period starting from midnight Sunday to the next midnight Sunday. Additional information related to this event includes the battery state of charge at the beginning of the problem and the minimum accessory voltage during the problematic period.

NO_EQU_LAST_WEEK

This event occurs if the vehicle has not undergone a sufficient equalization period during a complete period between a Sunday midnight and the following Sunday midnight. Additional information related to this event includes the battery state of charge at the beginning of the problem and the minimum accessory voltage during the problematic period.

SERV_SW_OFF_TODAY

The event occurs if the CPI does not detect 72V voltage during a complete daily cycle from midnight to midnight. Additional information related to this event includes the battery state of charge at the beginning of the problem and the minimum accessory voltage during the problematic period.

Software Functions—Daily Report Function

The daily report function has been designed to characterize different uses and thus allow technical adjustments or eventually make operating recommendations to clients. This function can also give details on abusive use of the vehicle even if it has not been developed for this purpose. The daily report is generated daily at midnight. Data from 2048 days can be stored.

Each daily report contains the following information:

Date, minimum main voltage, minimum accessory voltage, maximum motor speed, stop and go, minimum and maximum temperatures of the main batteries, minimum and maximum state of charge of main batteries, the total daily charge obtained by generation from the motor (REGEN), the daily total charge obtained from the charging system, total electrical discharge during the day, battery equalization time, vehicle operating time, and distance travelled.

All of these data are interesting for use in the evaluation of typical operation of the vehicle by a client and may also be used to calculate other operating parameters, including: average vehicle speed, maximum speed, average current, power consumption per kilometre and charging time, among others.

Software Function—Real Time Acquisition (RTA)

This function allows the CPI to transfer internal real time values with external devices, like a computer, as fast as each second. The available values are theses following:

Actual State of charge of battery (SOC), battery pack voltage, battery pack current, battery pack temperature, accessory battery voltage, motor speed, odometer, hour meter, motor overheat state, reverse button state, parking brake state, start relay state, charger state, fan state, heating state, defrost state, warning buzzer state.

The RTA function can be used to measure vehicle performances under specific conditions of a customer, without using significant test equipment. Only a laptop computer connected to the CPI can perform all the data acquisition needed.

With all these data in hand, it is possible to answer several questions related to operation of the vehicle by a client. Such questions include the following:

Does the client need a more powerful charger? If very often it is difficult to obtain a sufficiently high state of charge or if the battery equalization time is too low, or if the minimum state of charge during the day is too low even after several hours of charging, the operator might need a more powerful charging system. If the charge time is too low, one can recommend to the client to connect to a charging system more often or to add charging system stations. If daily operating rates are too high, it may be recommended that more vehicles are required for the client.

Is the vehicle speed limit adequate? If the average current is high one can deduce that the operator uses the vehicle often with a heavy load. One can than suggest to the operator to decrease vehicle speed to compensate for the power required for transportation of heavy loads.

Is temperature affecting significantly the performances? If minimum and maximum temperatures are too low too often and if the state of charge is very low often, one might suggest to the operator to increase the periods in which the vehicle is maintained in a heated environment or suggest physical modifications to the vehicle.

Is the rate of use of the vehicle adequate? Analysis of data over a complete year can lead to a conclusion of intensive use (SOC minimum and maximum too low) during a few weeks during the year and this would be considered to be acceptable. If intensive use becomes commonplace, changes may be suggested, including the purchase of additional vehicles.

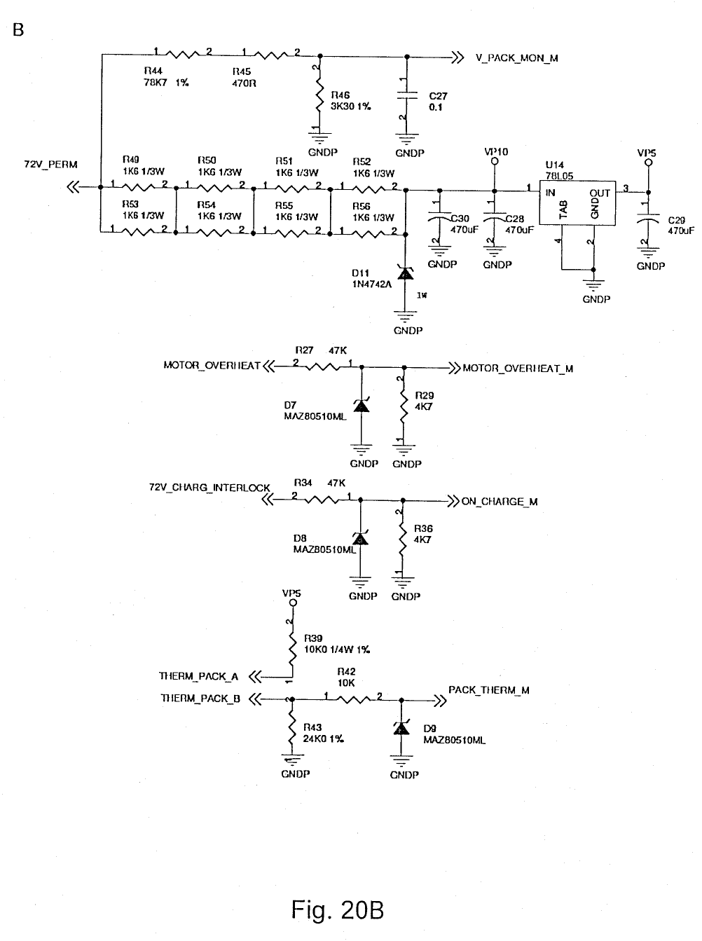

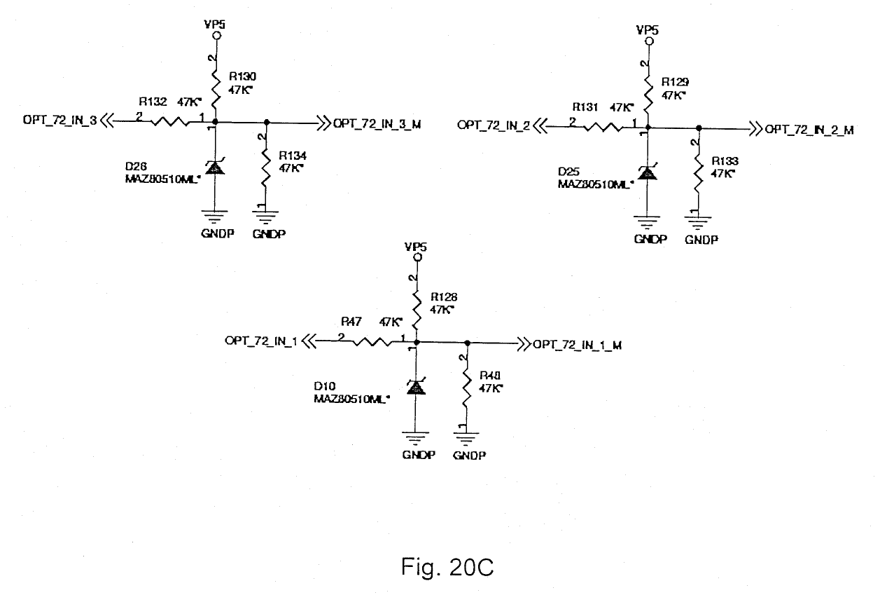

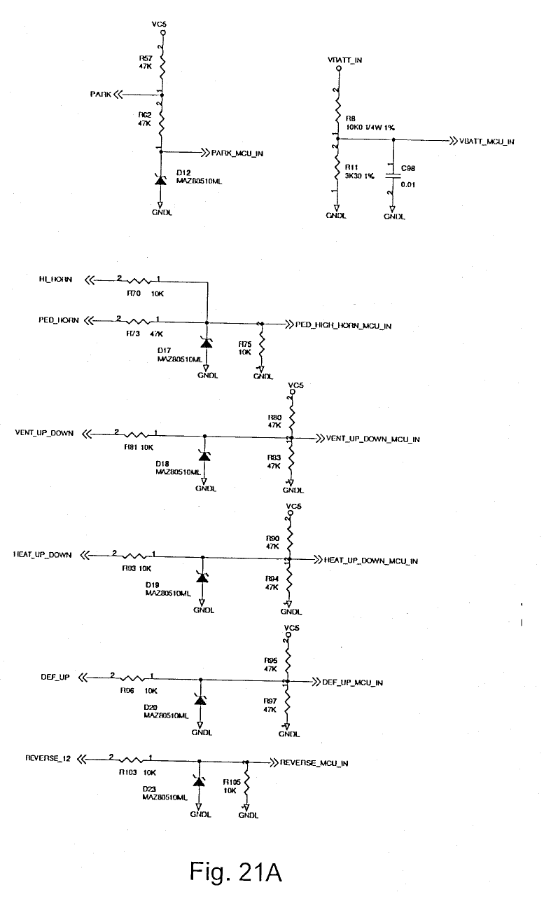

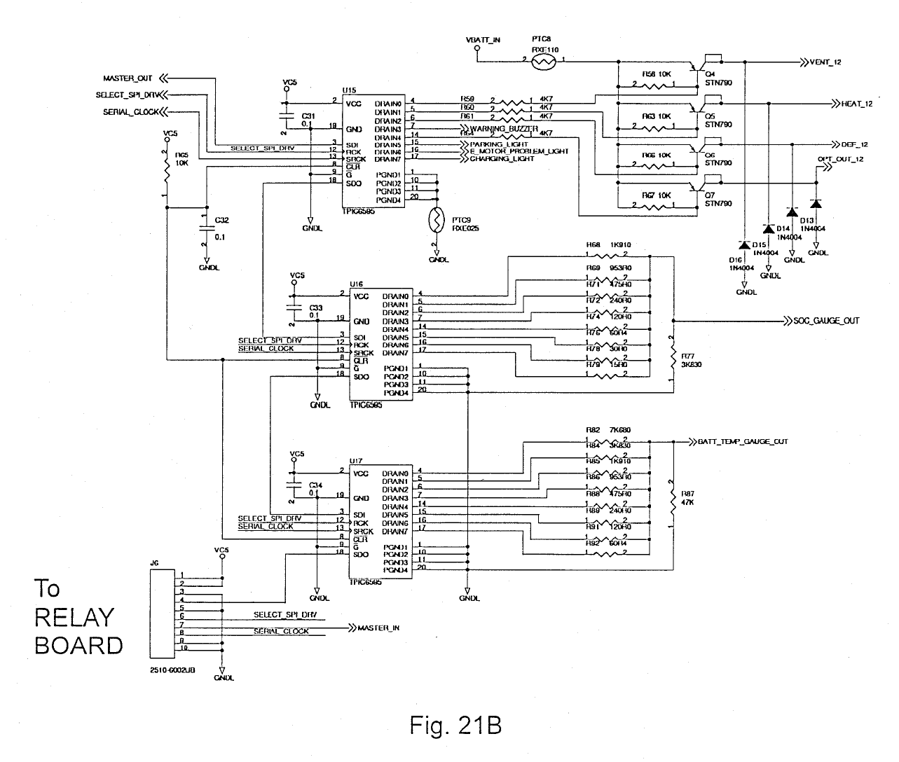

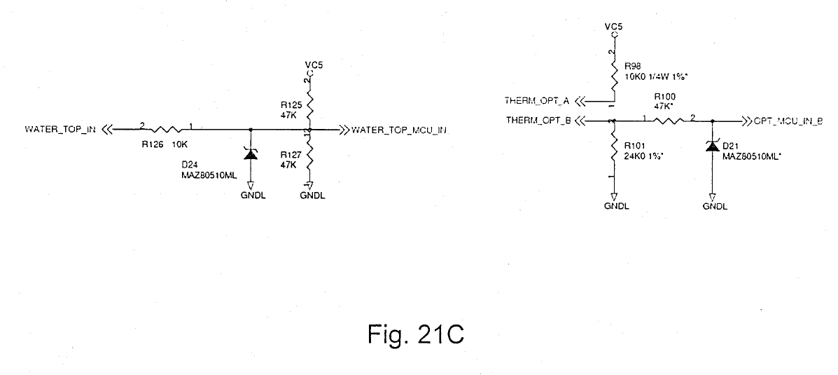

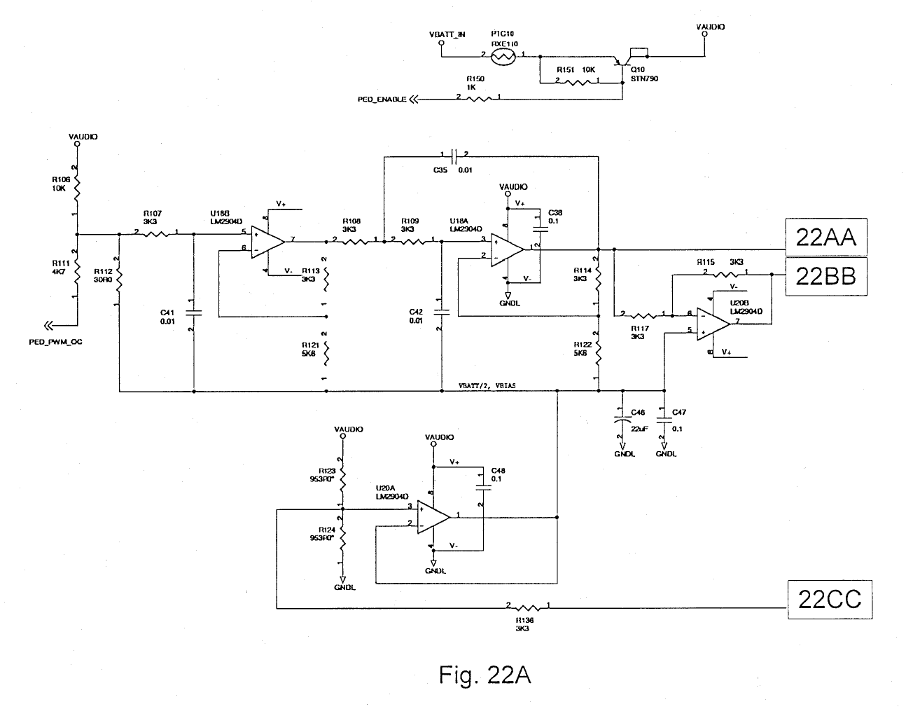

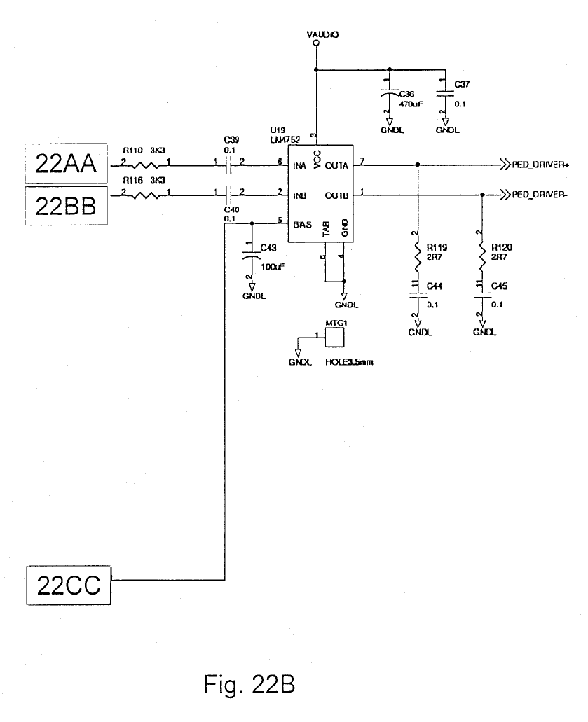

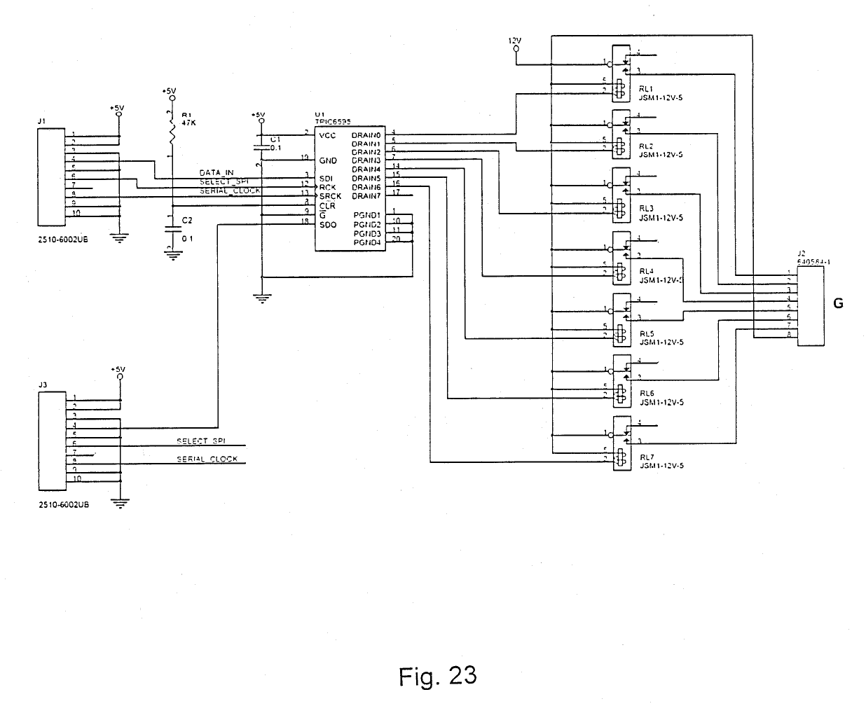

FIGS. 20 to 26 are other detailed schematic diagrams of the electronic assistance system according to a preferred embodiment of the present invention.

Although preferred embodiments of the present invention have been described in detail herein and illustrated in the accompanying drawings, it is to be understood that the invention is not limited to these precise embodiments and that various changes and modifications may be effected therein without departing from the scope or spirit of the present invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. An electronic assistance system for management of events related to the operation of an electrical vehicle, comprising:
a circuit for acquiring vehicle data for a plurality of parameters associated with operation of said vehicle;
a processor coupled to the circuit for processing said vehicle data in order to determine whether operation of the vehicle meets at least one pre-determined condition and for generating event data for at least one operating event if said vehicle data meets said pre-determined conditions;
control ports connected to the processor for control of vehicle subsystems in response to the vehicle and event data;
a user interface coupled to the processor for displaying, to an operator, the vehicle and event data;
a data recorder for recording said vehicle and event data;
a data output port, for connection to an external computer and for transmittal of the vehicle and event data to said computer, said processor and external computer generating at least one report characterizing the operating behavior of the vehicle,
wherein the vehicle data includes at least one parameter selected from the group comprising battery pack state of charge, battery pack voltage, power transitions, battery pack temperature, and motor speed and the event data includes minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometer and charging time.

2. An electronic assistance system according to claim 1, wherein the vehicle subsystems controlled through the control ports include at least one subsystem selected from the group comprising a motor, a heating system and a defroster.

3. An electronic assistance system according to claim 1, wherein the user interface includes a dashboard and an external loudspeaker.

4. An electronic assistance system according to claim 1, wherein the data output port is connected to a transmitter for transmitting to a receiver the vehicle and event data, the receiver being remotely located from the vehicle.

5. An electronic assistance system according to claim 4, wherein the receiver is connected to an application server, the application server generating and comparing one or more reports characterizing an operational behavior of a fleet of electrical vehicles.

6. An electronic assistance system according to claim 2, wherein the user interface includes a dashboard and an external loudspeaker.

7. An electronic assistance system according to claim 6, wherein the data output port is connected to a transmitter for transmitting to a receiver the vehicle and event data, the receiver being remotely located from the vehicle.

8. An electronic assistance system according to claim 7, wherein the receiver is connected to an application server, the application server generating and comparing one or more reports characterizing an operational behavior of a fleet of electrical vehicles.

9. A method for characterizing behavior related to the operation of an electrical vehicle, comprising:
acquiring vehicle data for a plurality of parameters associated with operation of said vehicle;
transmitting the vehicle data for the plurality of parameters associated with operation of said vehicle to a computer for real time analysis;
processing said vehicle data in order to determine whether operation of the vehicle meets at least one pre-determined condition;
generating event data for at least one operating event if said vehicle data meets said pre-determined conditions;
controlling vehicle subsystems in response to the vehicle and event data;
displaying, to an operator, the vehicle and event data;
recording said vehicle and event data;
transmitting to a computer the vehicle and event data, the computer generating at least one report characterizing an operating behavior of the vehicle,
wherein the vehicle data includes at least one parameter selected from the group comprising battery pack state of charge, battery pack voltage, power transitions, battery pack temperature, and motor speed and the event data includes minimum main voltage, minimum accessory voltage, maximum motor speed, minimum and maximum temperatures of main batteries, minimum and maximum state of charge of the main batteries, a total daily charge obtained by generation from a motor, a daily total charge obtained from a charging system, a total electrical discharge during the day, battery equalization time, vehicle operating time, and distance travelled, average vehicle speed, maximum speed, average current, power consumption per kilometer and charging time.

10. The method according to claim 9, wherein the subsystems controlled in response to the vehicle and event data include at least one system selected from the group comprising a motor, a heating system and a defroster.

11. The method according to claim 9, wherein the step of displaying to an operator the vehicle and event data is accomplished with a dashboard and an external loudspeaker.

12. The method according to claim 9, further comprising transmitting to a receiver the vehicle and event data, the receiver being remotely located from the vehicle.

13. The method according to claim 12, wherein the receiver is connected to an application server, the application server generating and comparing one or more reports characterizing an operational behavior of a fleet of electrical vehicles.

14. The method according to claim 10, wherein said displaying the vehicle and event data is accomplished with a dashboard and an external loudspeaker.

15. The method according to claim 10, further comprising transmitting to a receiver the vehicle and event data, the receiver being remotely located from the vehicle.

16. The method according to claim 15, wherein the receiver is connected to an application server, the application server generating and comparing one or more reports characterizing an operational behavior of a fleet of electrical vehicles.
